(19) United States
(12) Patent Application Publication
(10) Pub. No.: US 2017/0357494 A1
(43) Pub. Date: Dec. 14, 2017

(54) CODE-LEVEL MODULE VERIFICATION

(71) Applicant: International Business Machines Corporation, Armonk, NY (US)

(72) Inventors: Kenneth J. Owin, Tucson, AZ (US); David C. Reed, Tucson, AZ (US); Esteban Rios, Tucson, AZ (US); Max D. Smith, Tucson, AZ (US)

(73) Assignee: International Business Machines Corporation, Armonk, NY (US)

(21) Appl. No.: 15/176,300

(22) Filed: Jun. 8, 2016

(51) Int. Cl. G06F 9/445

(52) U.S. Cl. CPC G06F 8/65

(57) ABSTRACT

A method for verifying that software modules have a consistent code level is disclosed. In one embodiment, such a method includes updating a software product comprising a plurality of software modules. Upon updating the software product, the method updates a code-level table that documents an expected code level for each of the software modules. When a software module is called, the method determines an actual code level of the software module and compares the actual code level with the expected code level indicated in the code-level table. If the actual code level matches the expected code level, the method allows execution of the software module. If the actual code level does not match the expected code level, the method terminates execution of the software module. A corresponding system and computer program product are also disclosed.

### BACKGROUND

### Field of the Invention

This invention relates to systems and methods for verifying that software modules have a consistent code level.

### Background of the Invention

Many software products are made up of numerous software modules that invoke one another to accomplish various tasks. When a software product is updated to a desired “code level,” some or all of the software modules that make up the software product may be updated. In many cases, software modules need to be updated at the same time in order to properly work together. For example, if a first software module is configured to call a second software module and the first software module is updated to pass additional data or commands to the second software module, the second software module may need to be updated to understand and handle the additional data or commands. If the second software module is not updated, different errors may occur when the first software module calls the second software module. These errors may be hard to predict and may result is problems such as overlays (data written to or read from a wrong location, possibly overwriting other valuable data), abends (abnormal terminations), and/or hangs (delays) in a program. In some cases, system outages or data corruption may result.

Inconsistency across software modules may be the result of errors during a code update, incorrect procedures used by an installer, and/or undesired termination of installation procedures before they are complete. Many errors caused by inconsistent software modules may be unpredictable and very hard to diagnose and/or correct. This is at least partly because code as it exists on a user's system may not be in a normal state and may not match source code used by an engineer or technician to diagnose an error.

In view of the foregoing, what are needed are systems and methods to verify that software modules are in a consistent state. Ideally, such systems and methods will determine whether software modules have a consistent code level and, if not, take measures to prevent errors or improper execution, notify appropriate personnel, and/or update software modules to ensure consistency.

### SUMMARY

The invention has been developed in response to the present state of the art and, in particular, in response to the problems and needs in the art that have not yet been fully solved by currently available systems and methods. Accordingly, systems and methods have been developed to verify that software modules have a consistent code level. The features and advantages of the invention will become more fully apparent from the following description and appended claims, or may be learned by practice of the invention as set forth hereinafter.

Consistent with the foregoing, a method for verifying that software modules have a consistent code level is disclosed. In one embodiment, such a method includes updating a software product comprising a plurality of software modules. Upon updating the software product, the method updates a code-level table that documents an expected code level for each of the software modules. When a software module is called, the method determines an actual code level of the software module and compares the actual code level with the expected code level indicated in the code-level table. If the actual code level matches the expected code level, the method allows execution of the software module. If the actual code level does not match the expected code level, the method terminates execution of the software module.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system in which a system and method in accordance with the invention may be implemented;

FIG. 2 shows a code-level verification module that intercepts a call from a first software module to a second software module;

FIG. 3 is a high-level block diagram showing various sub-modules and tables used by the code-level verification module;

FIG. 4 is a process flow diagram showing a method for verifying consistency of software module code levels;

FIG. 5 is a process flow diagram showing a method for updating a code-level table and validation table when a software product is updated; and

FIG. 6 is a process flow diagram showing a method for marking a software module as “unvalidated” at the time it is unloaded from memory.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

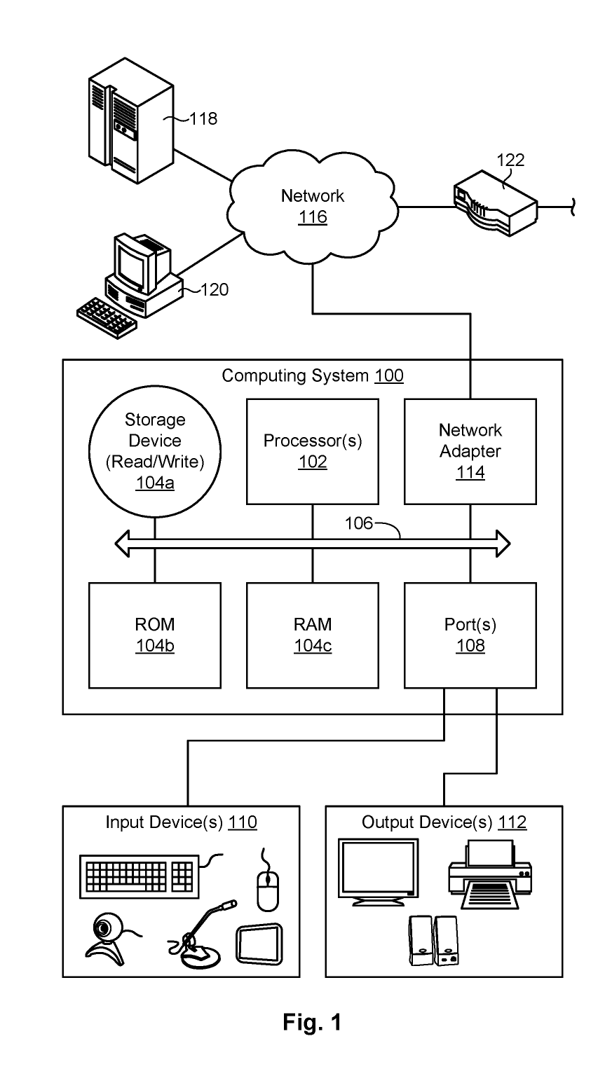

Referring to FIG. 1, one example of a computing system 100 is illustrated. The computing system 100 is presented to show one example of an environment where a system and method in accordance with the invention may be implemented. The computing system 100 may be embodied as a mobile device 100 such as a smart phone or tablet, a desktop computer, a workstation, a server, or the like. The computing system 100 is presented by way of example and is not intended to be limiting. Indeed, the systems and methods disclosed herein may be applicable to a wide variety of different computing systems in addition to the computing system 100 shown. The systems and methods disclosed herein may also potentially be distributed across multiple computing systems 100.

As shown, the computing system 100 includes at least one processor 102 and may include more than one processor 102. The processor 102 may be operably connected to a memory 104. The memory 104 may include one or more non-volatile storage devices such as hard drives 104a, solid state drives 104a, CD-ROM drives 104a, DVD-ROM drives 104a, tape drives 104a, or the like. The memory 104 may also include non-volatile memory such as a read-only memory 104b (e.g., ROM, EPROM, EEPROM, and/or Flash ROM) or volatile memory such as a random access memory 104c (RAM or operational memory). A bus 106, or plurality of buses 106, may interconnect the processor 102, memory devices 104, and other devices to enable data and/or instructions to pass therebetween.

To enable communication with external systems or devices, the computing system 100 may include one or more ports 108. Such ports 108 may be embodied as wired ports 108 (e.g., USB ports, serial ports, Firewire ports, SCSI ports, parallel ports, etc.) or wireless ports 108 (e.g., Bluetooth, IrDA, etc.). The ports 108 may enable communication with one or more input devices 110 (e.g., keyboards, mice, touchscreens, cameras, microphones, scanners, storage devices, etc.) and output devices 112 (e.g., displays, monitors, speakers, printers, storage devices, etc.). The ports 108 may also enable communication with other computing systems 100.

In certain embodiments, the computing system 100 includes a wired or wireless network adapter 114 to connect the computing system 100 to a network 116, such as a LAN, WAN, or the Internet. Such a network 116 may enable the computing system 100 to connect to one or more servers 118, workstations 120, personal computers 120, mobile computing devices, or other devices. The network 116 may also enable the computing system 100 to connect to another network by way of a router 122 or other device 122. Such a router 122 may allow the computing system 100 to communicate with servers, workstations, personal computers, or other devices located on different networks.

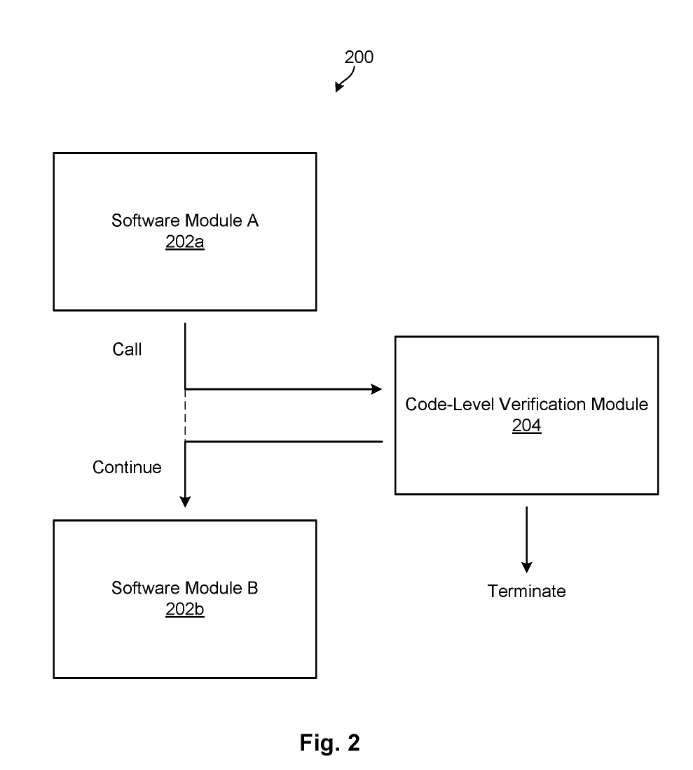

Referring to FIG. 2, as previously mentioned, software products 200 may be made up of numerous software modules 202 (such as CSECTs or other movable sections of program code) that invoke one another to accomplish different tasks. When a software product 200 is updated to a desired “code level,” some or all of the software modules 202 that make up the software product 200 may be updated. In some cases, software modules 202 may need to be updated at the same time to ensure they can work together properly. For example, as shown in FIG. 2, if a first software module 202a is designed to call a second software module 202b and the first software module 202a is updated to pass additional data or commands to the second software module 202b, the second software module 202b may need to be updated to understand and handle the additional data or commands. If the second software module 202b is not updated, various errors may occur when the first software module 202a calls the second software module 202b. The errors and associated symptoms may be hard to predict and may result is problems such as overlays, abends, and/or hangs in a program. In some cases, system outages or data corruption may result.

Inconsistency across software modules 202 may be the result of errors during a code update, incorrect procedures used by an installer, and/or undesired termination of installation procedures before they are complete. As mentioned above, many errors caused by inconsistent software modules 202 may be unpredictable and very hard to diagnose and/or correct. This is at least partly because code as it exists on a user's system may not be in the same state as source code used by an engineer or technician to diagnose an error.

In order to verify that software modules 202 are in a consistent state, a code-level verification module 204 may be provided. The code-level verification module 204 may be implemented in hardware, software, firmware, or combinations thereof. The code-level verification module 204 may be configured to determine whether software modules 202 have a consistent code level and, if not, take measures to prevent errors or improper execution, notify appropriate personnel, and/or update software modules 202 to ensure consistency.

As shown in FIG. 2, in certain embodiments, the code-level verification module 204 may be invoked each time a software module 202 is called. This may be accomplished by recompiling existing software modules 202 to invoke the code-level verification module 204, or the code-level verification module 204 may be configured to intercept calls between existing software modules 202 so as not to require recompiling of existing code. When the code-level verification module 204 is invoked, the code-level verification module 204 may verify that the software module 202b being called has a correct code level. If so, the code-level verification module 204 may enable continued execution of the software module 202b. If not, the code-level verification module 204 may terminate execution of the software module 202b and possibly perform remedial actions such an notifying a user and/or updating the software module 202b.

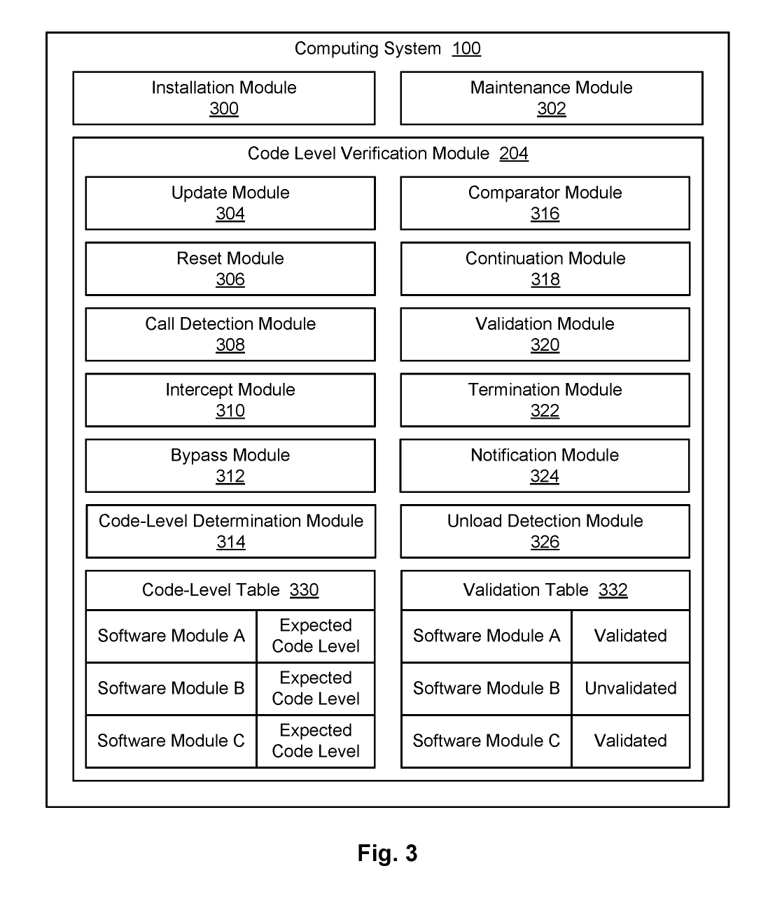

Referring to FIG. 3, in order to provide the features and function described above, the code-level verification module 204 may include various sub-modules. These sub-modules may include one or more of an update module 304, reset module 306, call detection module 308, intercept module 310, bypass module 312, code-level determination module 314, comparator module 316, continuation module 318, validation module 320, termination module 322, notification module 324, and unload detection module 326. These sub-modules may access one or more of a code-level table 330 and validation table 332. These sub-modules and tables are presented by way of example and are not intended to represent an exhaustive list of modules or tables that may be included within the code-level verification module 204. The code-level verification module 204 may include more or fewer modules than those illustrated, or the functionality of the modules may be organized differently.

As shown, a computing system 100 may, in certain embodiments, include an installation module 300 and/or maintenance module 302. The installation module 300 may be configured to manage installation of software products 200 on the computing system 100. For example, the installation module 300 may be configured to implement SMP/E (System Modification Program/Extended) which is a tool designed to manage the installation of software products on z/OS systems as well as track modifications thereto. Once a software product 200 is installed, the maintenance module 302 may be configured to maintain the software product 200, such as by applying patches and updates to the software product 200 as needed.

In order to ensure that software modules 202 are in a consistent state after they are installed or updated, the code-level verification module 204 may maintain a code-level table 330 that includes a list of software modules 202 and their expected code level, such as a fix number, version number, etc. Each software product 200 may have a separate code-level table 330 or a global code-level table 330 may be used for multiple software products 200. In certain embodiments, the code-level verification module 204 also maintains a validation table 332 that keeps track of software modules 202 that have been validated as having the correct code level. The information in the code-level table 330 and validation table 332 may in certain embodiments be combined into a single table or the information contained therein may be organized differently that what is illustrated. For example, the validation table 332 may in certain embodiments be implemented as an address hash table that stores addresses or ranges of addresses for software modules 202 that have been validated. Thus, the organization and manner in which data is stored in the code-level table 330 and validation table 332 may differ in different embodiments.

Each time a software product 200 is updated by the installation module 300 or maintenance module 302, the update module 304 may update the code-level table 330 to reflect the most updated version of the software modules 202 and expected code levels. When the update module 304 updates the code-level table 330, the reset module 306 may reset the validation table 332, such as by marking the updated software module 202 as “unvalidated,” or by simply removing the updated software module 202 or validation information (e.g., addresses or ranges of addresses associated with the updated software module 202) from the validation table 332.

When a software module 202 is called, the call detection module 308 may detect the call. In certain embodiments, the call detection module 308 is implemented as program code within a software module 202 that detects when the software module 202 is called and invokes functionality within the code-level verification module 204. As previously mentioned, this may be accomplished by recompiling existing software modules 202 to invoke functionality of the code-level verification module 204. Alternatively, the intercept module 310 may intercept calls between software modules 202 to invoke functionality of the code-level verification module 204, thereby eliminating the need to modify or recompile existing software modules 202.

When a software module 202 is called, the bypass module 312 may check the validation table 332 to determine whether the software module 202 has already been validated as having a correct code level. If so, the bypass module 312 may bypass validation procedures performed by the code-level verification module 204 and allow the software module 202 to continue execution.

If the bypass module 312 determines that a software module 202 has not been validated, the code-level determination module 314 may determine a code level of the software module 202. In certain embodiments, this may be accomplished by looking for an “eyecatcher” (e.g. descriptive text or sequence of bytes that has a low probability of randomly appearing in memory) that describes the code level of the software module 202 within the program code of the software module 202.

Once the code level of the software module 202 is determined, the comparator module 316 may compare the code level with the expected code level for the software module 202 that is listed in the code-level table 330. If the code levels match, the continuation module 318 may enable the software module 202 to continue executing and the validation module 320 may validate the software module 202 in the validation table 332, such as by marking it as “validated,” or adding the software module's name or address(es) to the validation table 332. This will allow the validation process to be bypassed the next time the software module 202 is called.

If the code level of the software module 202 does not match the expected code level in the code-level table 330, the termination module 322 may terminate the software module 202. In certain embodiments, the termination module 322 generates a new ABEND code that indicates a mismatch between the code level of the software module 202 and the expected code level, and performs a storage dump of the mismatched software module 202. The notification module 324 may optionally notify a user or administrator that the software module 202 has been terminated, and optionally indicate reasons for the termination.

The unload detection module 326 may detect when a software module 202 is unloaded from memory. While unloaded from memory, the software module 202 has the potential to be modified or updated in a way that causes its code level to change. Thus, when the software module 202 is unloaded from memory, the unload detection module 326 may remove the software module 202 from the validation table 332 or mark it as unvalidated. This will ensure that the software module 202 is once again revalidated when it is called.

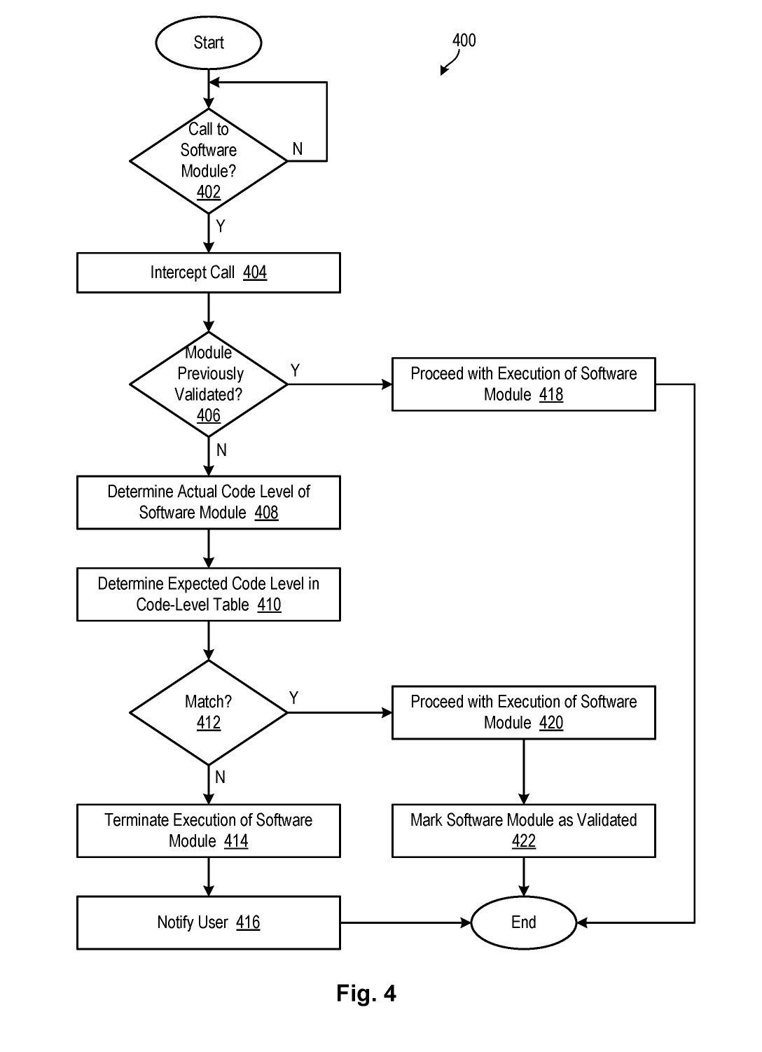

Referring to FIG. 4, one embodiment of a method 400 for verifying that software modules 202 have consistent code levels is illustrated. As shown, the method 400 initially determines 402 whether a software module 202 has been called. If a software module 202 has been called, the method 400 intercepts 404 the call and determines 406 whether the software module 202 was previously validated as having the correct code level. The method 400 may accomplish this by checking the validation table 332 previously discussed. If the software module 202 was previously validated, the method 400 skips the validation process and proceeds 418 with the execution of the software module 202 and the method 400 ends.

If, at step 406, the software module 202 was not previously validated (i.e., the software module 202 is not listed or validated in the validation table 332), the method 400 determines 408 the code level of the software module 202, such as by looking for an eyecatcher in the software module 202 that identifies its code level. The method 400 also determines 410 the expected code level for the software module 202 by looking in the code-level table 330. If the code level of the software module 202 matches 412 the expected code level, the method 400 proceeds 420 with the execution of the software module 202 and marks 422 the software module 202 as validated in the validation table 332. If the code level of the software module 202 does not match 412 the expected code level, the method 400 terminates 414 execution of the software module 202 and optionally notifies 416 a user or administrator of the termination and possibly the reasons for termination.

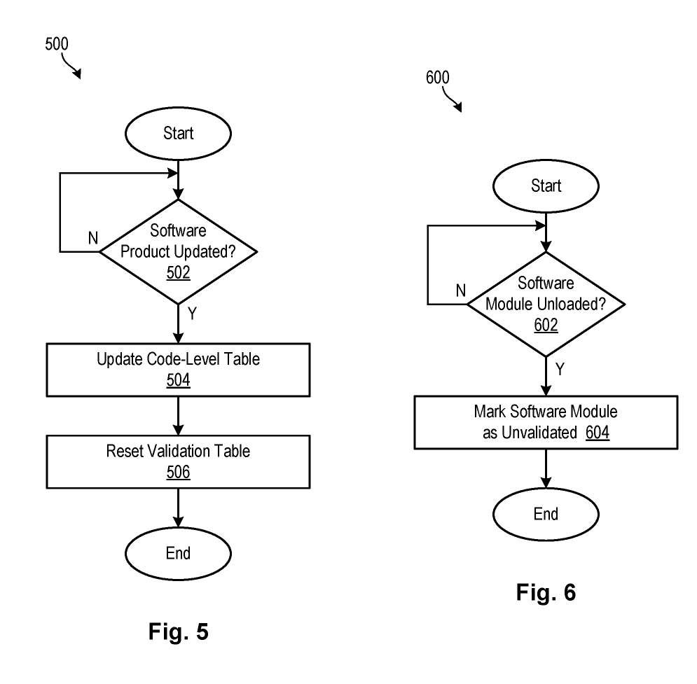

Referring to FIG. 5, one embodiment of a method 500 for updating the code-level table 330 and validation table 332 when a software product 200 is updated is illustrated. As shown, the method 500 determines 502 whether a software product 200 has been updated. If so, the method 500 updates 504 the code-level table 330 to indicate which software modules 202 associated with the software product 200 have had their code levels updated and records the expected code levels for these software modules 202. The method 500 also resets the validation table 332 so that the software modules 202 are marked as “unvalidated” or removed from the validation table 332. This may occur only for those software modules 202 that have been updated or are associated with a particular software product 200, or occur for all software modules 202 in the validation table 332.

Referring to FIG. 6, one embodiment of a method 600 for marking a software module 202 as unvalidated when it is unloaded from memory is illustrated. As previously mentioned, when a software module 202 is unloaded from memory, the software module 202 has the potential to be modified or updated, thereby causing its code level to change. Thus, when the method 600 detects 602 that a software module 202 has been unloaded from memory, the method 600 marks 604 the software module 202 as unvalidated or removes the software module 202 from the validation table 332. This will ensure that the software module 202 is revalidated the next time it is called.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for verifying that software modules have a consistent code level, the method comprising:
updating a software product comprising a plurality of software modules;
creating, for the updated software product, a code-level table that documents an expected code level for each of the software modules to work together properly;
upon calling a software module of the plurality of software modules, comparing an actual code level of the software module with the expected code level indicated in the code-level table;
in the event the actual code level matches the expected code level, allowing execution of the software module; and
in the event the actual code level does not match the expected code level, terminating execution of the software module.

2. The method of claim 1, wherein calling the software module comprises initially calling the software module.

3. The method of claim 2, further comprising, in the event the actual code level matches the expected code level, marking the software module as validated.

4. The method of claim 3, further comprising, prior to any future updates to the software product but after the software module has been validated, allowing execution of the software module without comparing the actual code level to the expected code level.

5. The method of claim 3, further comprising, in the event the software module is unloaded from memory, marking the software module as unvalidated.

6. The method of claim 3, further comprising, in the event the software product is once again updated, marking the software module as unvalidated.

7. The method of claim 1, wherein comparing the actual code level comprises looking for the actual code level within the software module.

8. A computer program product to verify that software modules have a consistent code level, the computer program product comprising a computer-readable storage medium having computer-usable program code embodied therein, the computer-usable program code comprising:
computer-usable program code to update a software product comprising a plurality of software modules;
computer-usable program code to create, for the updated software product, a code-level table that documents an expected code level for each of the software modules to work together properly;
computer-usable program code to, upon calling a software module of the plurality of software modules, compare an actual code level of the software module with the expected code level indicated in the code-level table;
computer-usable program code to, in the event the actual code level matches the expected code level, allow execution of the software module; and
computer-usable program code to, in the event the actual code level does not match the expected code level, terminate execution of the software module.

9. The computer program product of claim 8, wherein calling the software module comprises initially calling the software module.

10. The computer program product of claim 9, further comprising computer-usable program code to, in the event the actual code level matches the expected code level, mark the software module as validated.

11. The computer program product of claim 10, further comprising computer-usable program code to, prior to any future updates to the software product but after the software module has been validated, allow execution of the software module without comparing the actual code level to the expected code level.

12. The computer program product of claim 10, further comprising computer-usable program code to, in the event the software module is unloaded from memory, mark the software module as unvalidated.

13. The computer program product of claim 10, further comprising computer-usable program code to, in the event the software product is once again updated, mark the software module as unvalidated.

14. The computer program product of claim 8, wherein comparing the actual code level comprises looking for the actual code level within the software module.

15. A system to verify that software modules have a consistent code level, the system comprising:
at least one processor;
at least one memory device operably coupled to the at least one processor and storing instructions for execution on the at least one processor, the instructions causing the at least one processor to:
update a software product comprising a plurality of software modules;
create, for the updated software product, a code-level table that documents an expected code level for each of the software modules to work together properly;
upon calling a software module of the plurality of software modules, compare an actual code level of the software module with the expected code level indicated in the code-level table;
in the event the actual code level matches the expected code level, allow execution of the software module; and
in the event the actual code level does not match the expected code level, terminate execution of the software module.

16. The system of claim 15, wherein calling the software module comprises initially calling the software module.

17. The system of claim 16, wherein the instructions further cause the at least one processor to, in the event the actual code level matches the expected code level, mark the software module as validated.

18. The system of claim 17, wherein the instructions further cause the at least one processor to, prior to any future updates to the software product but after the software module has been validated, allow execution of the software module without comparing the actual code level to the expected code level.

19. The system of claim 17, wherein the instructions further cause the at least one processor to, in the event the software module is unloaded from memory, mark the software module as unvalidated.

20. The system of claim 17, wherein the instructions further cause the at least one processor to, in the event the software product is once again updated, mark the software module as unvalidated.
